(19) United States
(12) Patent Application Publication
(10) Pub. No.: US 2024/0164240 A1
(43) Pub. Date: May 23, 2024

(54) DISC BLADE ANGLE ADJUSTMENT SYSTEM FOR A TILLAGE IMPLEMENT

(71) Applicant: CNH Industrial America LLC, New Holland, PA (US)

(72) Inventor: Joshua David Knoblauch, Lowpoint, IL (US)

(21) Appl. No.: 17/991,897

(22) Filed: Nov. 22, 2022

(51) Int. Cl. A01B 79/00; A01B 35/16; A01B 63/00; A01B 63/14

(52) U.S. Cl. CPC A01B 79/005; A01B 35/16; A01B 63/002; A01B 63/14

(57) ABSTRACT

A disc blade angle adjustment system for a tillage implement includes a controller having a memory and a processor. The controller is configured to control a front row actuator to adjust a front angle of a front row of disc blades relative to a lateral axis of the tillage implement based on an amount of residue at a location of the tillage implement. In addition, the controller is configured to control a rear row actuator to adjust a rear angle of a rear row of disc blades relative to the lateral axis of the tillage implement based on a degree of soil compaction at the location of the tillage implement.

### BACKGROUND

The present disclosure relates to a disc blade angle adjustment system for a tillage implement.

Certain agricultural implements include ground engaging tools configured to interact with soil. For example, a tillage implement may include disc blades configured to break up the soil for subsequent planting or seeding operations. Groups of disc blades may be arranged in gangs, and each gang of disc blades may be rotatably coupled to a frame of the tillage implement. In certain tillage implements, an angle of each gang is adjustable relative to the frame, thereby facilitating adjustment of an angle of the disc blades of the gang relative to a direction of travel of the tillage implement. For example, the gang of disc blades may be rotatably coupled to a gang support, and the gang support may be pivotally coupled to the frame of the tillage implement. Accordingly, prior to tilling operations, the angle of the disc blades of the gang relative to the direction of travel may be adjusted by rotating the gang support relative to the frame.

### BRIEF DESCRIPTION

In certain embodiments, a disc blade angle adjustment system for a tillage implement includes a controller having a memory and a processor. The controller is configured to control a front row actuator to adjust a front angle of a front row of disc blades relative to a lateral axis of the tillage implement based on an amount of residue at a location of the tillage implement. In addition, the controller is configured to control a rear row actuator to adjust a rear angle of a rear row of disc blades relative to the lateral axis of the tillage implement based on a degree of soil compaction at the location of the tillage implement.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a tillage implement having a disc blade angle adjustment system:

FIG. 2 is a block diagram of an embodiment of a disc blade angle adjustment system that may be employed within the tillage implement of FIG. 1, in which a front row of disc blades is oriented at a first front angle and a rear row of disc blades is oriented at a first rear angle: and

FIG. 3 is a block diagram of the disc blade angle adjustment system of FIG. 2, in which the front row of disc blades is oriented at a second front angle and the rear row of disc blades is oriented at a second rear angle.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

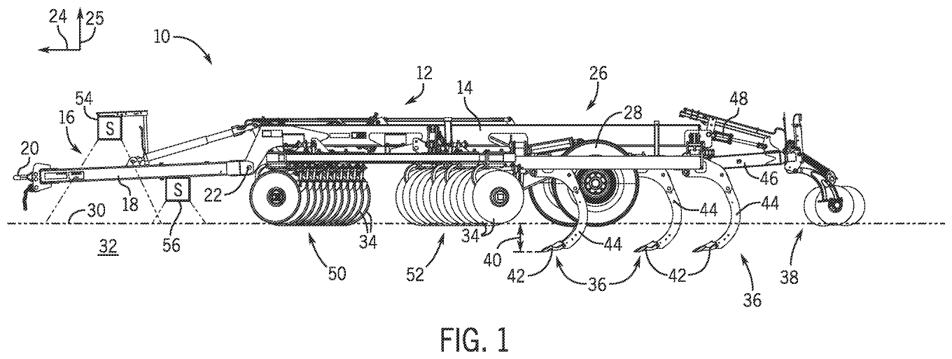

FIG. 1 is a side view of an embodiment of a tillage implement 10 (e.g., agricultural tillage implement) having a disc blade angle adjustment system 12. In the illustrated embodiment, the tillage implement 10 is a primary tillage implement having multiple ground engaging tools configured to till soil. As illustrated, the tillage implement 10 includes a frame 14 and a hitch assembly 16 coupled to the frame 14. The hitch assembly 16 includes a hitch frame 18 and a hitch 20. The hitch frame 18 is pivotally coupled to the implement frame 14 via pivot joint(s) 22, and the hitch 20 is configured to couple to a corresponding hitch of a work vehicle (e.g., tractor), which is configured to tow the tillage implement 10 through a field along a direction of travel 24. While the hitch frame 18 is pivotally coupled to the implement frame 14 in the illustrated embodiment, in other embodiments, the hitch frame may be movably coupled to the implement frame by a linkage assembly (e.g., four bar linkage assembly, etc.) or another suitable assembly/mechanism that enables the hitch to move vertically (e.g., along a vertical axis 25) relative to the implement frame.

As illustrated, the tillage implement 10 includes wheel assemblies 26 movably coupled to the implement frame 14. In the illustrated embodiment, each wheel assembly 26 includes a wheel frame and a wheel 28 rotatably coupled to the wheel frame. The wheels 28 of the wheel assemblies 26 are configured to engage the surface 30 of the soil 32, and the wheel assemblies 26 are configured to support at least a portion of the weight of the tillage implement 10. In the illustrated embodiment, each wheel frame is pivotally coupled to the implement frame 14, thereby facilitating adjustment of the position of each wheel 28 along the vertical axis 25. However, in other embodiments, at least one wheel frame may be movably coupled to the implement frame by another suitable connection (e.g., sliding connection, linkage assembly, etc.) that facilitates adjustment of the vertical position of the respective wheel(s). In certain embodiments, the tillage implement may include two wheel assemblies 26. However, in other embodiments, the tillage implement may include more or fewer wheel assemblies (e.g., 0, 1, 2, 3, 4, 5, 6, 7, 8, or more). In addition, each wheel assembly may include any suitable number of wheels (e.g., 1, 2, 3, 4, 5, 6, or more). Furthermore, in certain embodiments, the wheel assemblies may be omitted.

In the illustrated embodiment, the tillage implement 10 includes ground engaging tools, such as the illustrated disc blades 34, tillage point assemblies 36, and finishing discs 38. The disc blades 34 are configured to engage a top layer of the soil 32. As the tillage implement 10 is towed through the field, the disc blades 34 are driven to rotate, thereby breaking up the top layer. In the illustrated embodiment, the disc blades 34 are arranged in two rows. However, in other embodiments, the disc blades may be arranged in more rows (e.g., 3, 4, 5, 6, or more). In addition, as discussed in detail below, the disc blade angle adjustment system 12 is configured to control the angles of the rows of disc blades 34 relative to a lateral axis of the tillage implement 10 to control the interaction of the disc blades 34 with the top layer of soil 32. The tillage point assemblies 36 are configured to engage the soil 32 at a greater depth 40, thereby breaking up a lower layer of the soil. Each tillage point assembly 36 includes a tillage point 42 and a shank 44. The shank 44 is configured to position the tillage point 42 at the depth 40 beneath the soil surface 30, and the tillage point 42 is configured to break up the soil. The shape of each tillage point 42, the arrangement of the tillage point assemblies 36, and the number of tillage point assemblies 36 may be selected to control tillage within the field. Furthermore, as the tillage implement 10 is towed through the field, the finishing discs 38 are driven to rotate, thereby sizing soil clods, leveling the soil surface, smoothing the soil surface, cutting residue on the soil surface, or a combination thereof.

In the illustrated embodiment, the finishing discs 38 are rotatably coupled to a finishing disc frame 46, and the finishing disc frame 46 is pivotally coupled to the implement frame 14. In addition, biasing member(s) 48 extend between the implement frame 14 and the finishing disc frame 46. The biasing member(s) 48 are configured to urge the finishing disc frame 46 toward the surface 30 of the soil 32, thereby driving the finishing discs 38 to engage the soil. While the finishing disc frame is pivotally coupled to the implement frame in the illustrated embodiment, in other embodiments, the finishing disc frame may be movably coupled to the implement frame by a linkage assembly (e.g., four bar linkage assembly, etc.) or another suitable assembly/mechanism that enables the finishing disc frame to move vertically relative to the implement frame. Furthermore, in certain embodiments, the finishing disc frame may be non-translatably and/or non-rotatably coupled to the implement frame, or the finishing disc frame may be omitted, and the finishing discs may be coupled to the implement frame.

While the illustrated tillage implement includes the disc blades 34, the tillage point assemblies 36, and the finishing discs 38, in other embodiments, the tillage implement may include other and/or additional ground engaging tool(s). For example, the tillage point assemblies and/or the finishing discs may be omitted in certain embodiments. Furthermore, in certain embodiments, the tillage implement may include one or more other suitable ground engaging tools, such as coulter(s), reel(s), and tine(s), among other suitable ground engaging tools. Furthermore, while the tillage implement 10 is a primary tillage implement in the illustrated embodiment, in other embodiments, the tillage implement may be a vertical tillage implement, or another suitable type of tillage implement. In addition, while the tillage implement 10 is configured to be towed by a work vehicle in the illustrated embodiment, in other embodiments, the tillage implement may be self-propelled.

As discussed in detail below, the disc blade angle adjustment system 12 is configured to control angles of the rows of disc blades 34 based on field conditions. In certain embodiments, the disc blade angle adjustment system 12 includes a controller having a memory and a processor. The controller is configured to control a front row actuator to adjust a front angle of a front row 50 of disc blades 34 relative to a lateral axis of the tillage implement 10 based on an amount of residue at a location of the tillage implement 10 within the field. For example, in response to a decrease in the amount of residue at the location of the tillage implement, the controller may control the front row actuator to reduce the front angle, and in response to an increase in the amount of residue at the location of the tillage implement, the controller may control the front row actuator to increase the front angle. Furthermore, the controller is configured to control a rear row actuator to adjust a rear angle of a rear row 52 of disc blades 34 relative to the lateral axis of the tillage implement 10 based on a degree of soil compaction at the location of the tillage implement. For example, in response to a decrease in the degree of soil compaction at the location of the tillage implement, the controller may control the rear row actuator to reduce the rear angle, and in response to an increase in the degree of soil compaction at the location of the tillage implement, the controller may control the rear row actuator to increase the rear angle. Accordingly, as the amount of residue and the degree of soil compaction varies throughout the field, the disc blade angle adjustment system 12 may automatically adjust the front angle of the front row 50 of disc blades 34 and the rear angle of the rear row 52 of disc blades 34, thereby enhancing the effectiveness of the tilling process (e.g., as compared to a tillage implement having a fixed front angle and/or a fixed rear angle).

In the illustrated embodiment, the disc blade angle adjustment system 12 includes a residue sensor 54 configured to output a sensor signal indicative of the amount of residue at the location of the tillage implement 10 within the field. The controller is configured to determine the amount of residue at the location of the tillage implement 10 based on the sensor signal. The residue sensor 54 may include any suitable type(s) of sensing device(s) configured to monitor the amount of residue at the location of the tillage implement 10. For example, in certain embodiments, the residue sensor 54 may include optical sensor(s), such as camera(s), and the sensor signal may be indicative of image(s) of the field surface. In such embodiments, the controller may determine the amount of residue at the location of the tillage implement based on the image(s). Furthermore, in certain embodiments, the residue sensor 54 may include radar(s), and the sensor signal may be indicative of one-dimensional or two-dimensional radar return(s). In such embodiments, the controller may determine the amount of residue at the location of the tillage implement based on the radar return(s). In addition, in certain embodiments, the residue sensor 54 may include ultrasonic transducer(s), infrared camera(s), infrared emitter(s)/detector(s), capacitive sensor(s), electrostatic sensor(s), other suitable type(s) of sensing device(s), or a combination thereof.

As illustrated, the residue sensor 54 is positioned forward of the front row 50 of disc blades 34 relative to the direction of travel 24, thereby enabling the residue sensor 54 to monitor the amount of residue within a region in front of the front row 50 of disc blades 34. For example, in certain embodiments, the residue sensor 54 may be positioned a sufficient distance forward of the front row 50 of disc blades 34 to enable the front row actuator to drive the front row 50 of disc blades 34 to a target orientation/through an adjustment increment before/as the front row 50 of disc blades 34 engages the residue monitored by the residue sensor 54. Furthermore, in certain embodiments, the controller may delay initiating the control of the front row actuator, such that the front row 50 of disc blades 34 reaches the target orientation/rotates through the adjustment increment before/as the front row 50 of disc blades 34 engages the residue monitored by the residue sensor 54. In the illustrated embodiment, the residue sensor 54 is coupled to the hitch frame 18. However, in other embodiments, the residue sensor may be coupled to the implement frame, to any other suitable component of the tillage implement, or to the work vehicle. Furthermore, while the residue sensor is positioned forward of the front row of disc blades relative to the direction of travel in the illustrated embodiment, in other embodiments, the residue sensor may be positioned at or rearward of the front row of disc blades relative to the direction of travel. In addition, while the disc blade angle adjustment system 12 includes a single residue sensor 54 in the illustrated embodiment, in other embodiments, the disc blade angle adjustment system may include multiple residue sensors (e.g., distributed laterally/relative to the lateral axis of the tillage implement and/or relative to the direction of travel of the tillage implement). Furthermore, in certain embodiments, the residue sensor may be omitted.

In the illustrated embodiment, the disc blade angle adjustment system 12 includes a soil compaction sensor 56 configured to output a sensor signal indicative of the degree of soil compaction at the location of the tillage implement 10 within the field. The controller is configured to determine the degree of soil compaction at the location of the tillage implement 10 based on the sensor signal. The soil compaction sensor 56 may include any suitable type(s) of sensing device(s) configured to monitor the degree of soil compaction at the location of the tillage implement 10. For example, in certain embodiments, the soil compaction sensor 56 may include electromagnetic sensor(s), ground penetrating radar(s), other suitable non-contact sensing device(s) configured to monitor the degree of soil compaction, or a combination thereof. Additionally or alternatively, in certain embodiments, the soil compaction sensor 56 may include contact sensor(s), each including a ground-penetrating element. In such embodiments, the sensor signal output by the soil compaction sensor may be indicative of force(s) applied to the ground-penetrating element(s), and the controller may be configured to determine the degree of soil compaction based on the force(s) applied to the ground-penetrating element(s).

As illustrated, the soil compaction sensor 56 is positioned forward of the rear row 52 of disc blades 34 relative to the direction of travel 24, thereby enabling the soil compaction sensor 56 to monitor the degree of soil compaction within a region in front of the rear row 52 of disc blades 34. For example, in certain embodiments, the soil compaction sensor 56 may be positioned a sufficient distance forward of the rear row 52 of disc blades 34 to enable the rear row actuator to drive the rear row 52 of disc blades 34 to a target orientation/through an adjustment increment before/as the rear row 52 of disc blades 34 engages the soil monitored by the soil compaction sensor 56. Furthermore, in certain embodiments, the controller may delay initiating the control of the rear row actuator, such that the rear row 52 of disc blades 34 reaches the target orientation/rotates through the adjustment increment before/as the rear row 52 of disc blades 34 engages the soil monitored by the soil compaction sensor 56. In the illustrated embodiment, the soil compaction sensor 56 is coupled to the hitch frame 18. However, in other embodiments, the soil compaction sensor may be coupled to the implement frame, to any other suitable component of the tillage implement, or to the work vehicle. Furthermore, while the soil compaction sensor is positioned forward of the rear row of disc blades relative to the direction of travel in the illustrated embodiment, in other embodiments, the soil compaction sensor may be positioned at or rearward of the rear row of disc blades relative to the direction of travel. In addition, while the disc blade angle adjustment system 12 includes a single soil compaction sensor 56 in the illustrated embodiment, in other embodiments, the disc blade angle adjustment system may include multiple soil compaction sensors (e.g., distributed laterally/relative to the lateral axis of the tillage implement and/or relative to the direction of travel of the tillage implement). Furthermore, in certain embodiments, the soil compaction sensor may be omitted.

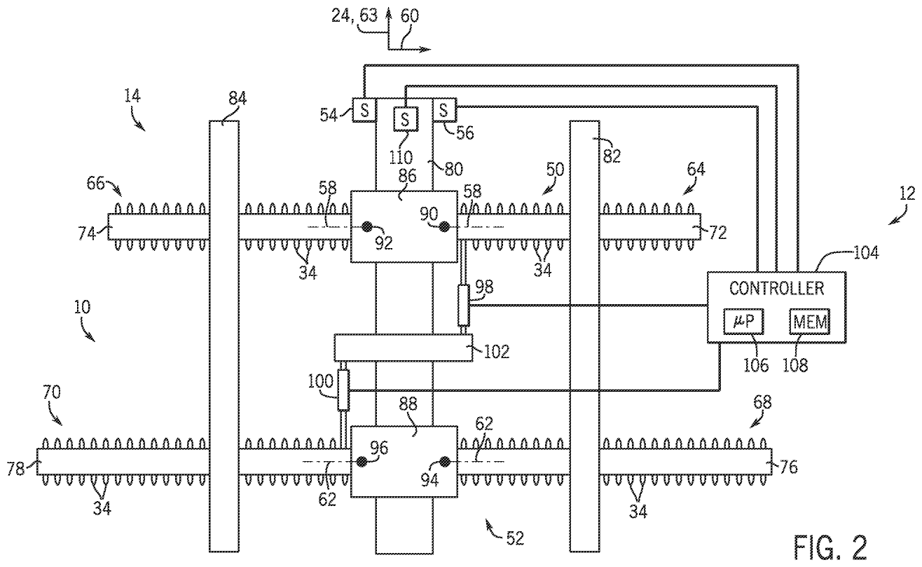

FIG. 2 is a block diagram of an embodiment of a disc blade angle adjustment system 12 that may be employed within the tillage implement 10 of FIG. 1. As illustrated, the front row 50 of disc blades 34 is oriented at a front angle 58 (e.g., first front angle) relative to a lateral axis 60 of the tillage implement 10, and the rear row 52 of disc blades 34 is oriented at a rear angle 62 (e.g., first rear angle) relative to the lateral axis 60 of the tillage implement 10. The lateral axis 60 of the tillage implement 10 may be substantially perpendicular to the direction of travel 24 of the tillage implement 10 (e.g., which may be substantially aligned with a longitudinal axis 63 of the tillage implement). While the tillage implement 10 is in the illustrated configuration, the front angle 58 is zero degrees, and the rear angle 62 is zero degrees. Accordingly, the rows of disc blades 34 are parallel to one another, and the disc blades 34 of the front and rear rows are substantially aligned with (e.g., parallel to) the direction of travel 24.

As used herein with regard to the rows of disc blades, the front row of disc blades 50 is forward of the rear row of disc blades 52 relative to the longitudinal axis 63. In certain embodiments, the agricultural implement may include one or more additional rows of disc blades. In such embodiments, the front row of disc blades is forward of the rear row of disc blades relative to the longitudinal axis. In certain embodiments, the front row of disc blades may be the first row of disc blades along the longitudinal axis, and/or the rear row of disc blades may be the last row of disc blades along the longitudinal axis. However, in certain embodiments, at least one row of disc blades may be forward of the front row of disc blades along the longitudinal axis, and/or at least one row of disc blades may be rearward of the rear row of disc blades along the longitudinal axis.

In the illustrated embodiment, the front row 50 of disc blades 34 includes a right section 64 (e.g., first section) and a left section 66 (e.g., second section), and each section of the front row 50 of disc blades 34 is pivotable relative to the frame 14. In addition, in the illustrated embodiment, the rear row 52 of disc blades 34 includes a right section 68 (e.g., first section) and a left section 70 (e.g., second section), and each section of the rear row 52 of disc blades 34 is pivotable relative to the frame 14. While the front row 50 of disc blades 34 has two sections in the illustrated embodiment, in other embodiments, the front row of disc blades may have more or fewer sections (e.g., 1, 3, 4, 5, 6, or more). Furthermore, while the rear row 52 of disc blades 34 has two sections in the illustrated embodiment, in other embodiments, the rear row of disc blades may have more or fewer sections (e.g., 1, 3, 4, 5, 6, or more). Furthermore, as used herein with respect to the tillage implement 10, “row” refers to an arrangement of disc blades 34 that extends laterally/relative to the lateral axis 60 and does not overlap another row along the longitudinal axis 63.

In certain embodiments, the disc blades 34 of each section are non-rotatably coupled to one another by a respective shaft, such that the disc blades 34 of each section are arranged in a gang and rotate together. Each shaft is rotatably coupled to a respective disc blade support, which is configured to support the gang, including the shaft and the disc blades 34. In the illustrated embodiment, the disc blades 34 of the right section 64 of the front row 50 are supported by a front right disc blade support 72 (e.g., first front disc blade support), the disc blades 34 of the left section 66 of the front row 50 are supported by a front left disc blade support 74 (e.g., second front disc blade support), the disc blades 34 of the right section 68 of the rear row 52 are supported by a rear right disc blade support 76 (e.g., first rear disc blade support), and the disc blades 34 of the left section 70 of the rear row 52 are supported by a rear left disc blade support 78 (e.g., second rear disc blade support). Furthermore, each disc blade support is pivotally coupled to the frame 14, thereby enabling the disc blade support to rotate relative to the frame 14. Rotating the disc blade support relative to the frame 14 controls the angle between the respective disc blades 34 and the direction of travel 24, thereby controlling the interaction of the disc blades 34 with the top layer of the soil.

Each disc blade support may include any suitable structure(s) configured to support the respective disc blades (e.g., including a square tube, a round tube, a bar, a truss, other suitable structure(s), or a combination thereof). While arranging the disc blades 34 of each section in a gang is disclosed above, in certain embodiments, at least a portion of the disc blades of at least one section (e.g., all of the disc blades of the at least one section) may be arranged in another suitable configuration (e.g., individually mounted and independently rotatable, mounted in groups and individually rotatable, arranged in multiple gangs, etc.). For example, in certain embodiments, a first portion of the disc blades in a section may be arranged in a gang, and a second portion of the disc blades in the section may be individually mounted and independently rotatable.

In the illustrated embodiment, the frame 14 includes a central longitudinal member 80, a first outward longitudinal member 82, and a second outward longitudinal member 84. Each member of the frame 14 may include any suitable structure(s) configured to support the rows of disc blades (e.g., including a square tube, a round tube, a bar, a truss, other suitable structure(s), or a combination thereof). Furthermore, the central longitudinal member 80, the first outward longitudinal member 82, and the second outward longitudinal member 84 are coupled to one another (e.g., by one or more cross-members) to form a substantially rigid frame 14.

Furthermore, in the illustrated embodiment, the frame 14 includes a front slider 86 and a rear slider 88, and each slider is slidably coupled to the central longitudinal member 80. Each slider may be slidably coupled to the central longitudinal member by any suitable type(s) of slidable connection(s). For example, in certain embodiments, at least one slider may include roller bearings configured to engage the central longitudinal member, the central longitudinal member may include roller bearings configured to engage at least one slider, the central longitudinal member and/or at least one slider may include bushing(s), at least one slider may be slidably coupled to the central longitudinal member by a track system, or a combination thereof.

Furthermore, in the illustrated embodiment, each disc blade support is pivotally coupled to a slider. As illustrated, the front right disc blade support 72 is pivotally coupled to the front slider 86 at a front right pivot joint 90, the front left disc blade support 74 is pivotally coupled to the front slider 86 at a front left pivot joint 92, the rear right disc blade support 76 is pivotally coupled to the rear slider 88 at a rear right pivot joint 94, and the rear left disc blade support 78 is pivotally coupled to the rear slider 88 at a rear left pivot joint 96. Each pivot joint may include any suitable element(s) (e.g., bearing(s), bushing(s), pin(s), fastener(s), etc.) configured to facilitate rotation of the respective disc blade support relative to the respective slider.

In addition, each disc blade support is pivotally and translatably coupled to an outward longitudinal member (e.g., at an interface laterally outward from the slider/central longitudinal member), thereby enabling the disc blade support to rotate relative to the outward longitudinal member and to translate laterally relative to the outward longitudinal member. Longitudinal movement of the disc blade support relative to the outward longitudinal member is substantially blocked. As illustrated, the front right disc blade support 72 is pivotally and translatably coupled to the first outward longitudinal member 82, the front left disc blade support 74 is pivotally and translatably coupled to the second outward longitudinal member 84, the rear right disc blade support 76 is pivotally and translatably coupled to the first outward longitudinal member 82, and the rear left disc blade support 78 is pivotally and translatably coupled to the second outward longitudinal member 84. Each disc blade support may be pivotally and translatably coupled to the respective outward longitudinal member by any suitable type(s) of connection(s). For example, in certain embodiments, at least one disc blade support may extend through an opening in the respective outward longitudinal member. Furthermore, in certain embodiments, a pin may be coupled to an outward longitudinal member, and the pin may be engaged with a slot in the respective disc blade support to enable the respective disc blade support to rotate relative to the outward longitudinal member and to translate laterally relative to the outward longitudinal member. In addition, in certain embodiments, the agricultural implement may include one or more bearings and/or one or more bushings to facilitate rotation and translation of the disc blade support(s) relative to the respective outward longitudinal member(s).

As previously discussed, in certain embodiments, the front row of disc blades may include a single section, and/or the rear row of disc blades may include a single section. In embodiments in which the front row of disc blades includes a single section and the rear row of disc blades includes a single section, and the single sections are positioned on the same lateral side of the central longitudinal member, the outward longitudinal member on the other lateral side of the central longitudinal member may be omitted.

In the illustrated embodiment, the disc blade angle adjustment system 12 includes a front row actuator 98 configured to adjust the front angle 58 of the front row 50 of disc blades 34 relative to the lateral axis 60 of the tillage implement 10. In addition, the disc blade angle adjustment system 12 includes a rear row actuator 100 configured to adjust the rear angle 62 of the rear row 52 of disc blades 34 relative to the lateral axis 60 of the tillage implement 10. Each row actuator may include any suitable type(s) of actuating device(s), such as hydraulic cylinder(s), electric linear actuator(s), electric motor(s), hydraulic motor(s), pneumatic motor(s), pneumatic cylinder(s), other suitable type(s) of actuating device(s), or a combination thereof.

In the illustrated embodiment, the central longitudinal member 80 includes a mount 102, and the front and rear row actuators are coupled (e.g., pivotally coupled) to the mount 102. In addition, the front row actuator 98 is coupled (e.g., pivotally coupled) to the front right disc blade support 72, and the rear row actuator 100 is coupled (e.g., pivotally coupled) to the rear left disc blade support 78. Accordingly, extension and retraction of each row actuator drives the respective row of disc blades to rotate relative to the lateral axis, thereby controlling the angle of the respective disc blades relative to the direction of travel. While the front row actuator 98 is coupled to the front right disc blade support 72 in the illustrated embodiment, in other embodiments, the front row actuator may be coupled to the front left disc blade support and/or to the front slider (e.g., alone or in combination with the front right disc blade support). In addition, while the rear row actuator 100 is coupled to the rear left disc blade support 78 in the illustrated embodiment, in other embodiments, the rear row actuator may be coupled to the rear right disc blade support and/or to the rear slider (e.g., alone or in combination with the rear left disc blade support). Furthermore, while each row actuator is coupled to the central longitudinal member 80 via the mount 102 in the illustrated embodiment, in other embodiments, at least one row actuator may be coupled directly to the central longitudinal member or to another suitable component of the implement frame. In addition, in embodiments in which at least one row actuator includes a motor, the motor may drive the respective slider to move via a wheel/gear rotatably coupled to the slider and engaged with the central longitudinal member, the motor may drive a cable/chain to move the slider along the central longitudinal member, or the motor may drive another suitable mechanism to move the slider relative to the central longitudinal member.

In the illustrated embodiment, the disc blade angle adjustment system 12 includes a controller 104 communicatively coupled to the front row actuator 98 and to the rear row actuator 100. In embodiments in which the row actuator includes an electrical actuator, the electrical actuator may be directly communicatively (e.g., electrically) coupled to the controller. In embodiments in which the row actuator includes a fluid (e.g., hydraulic or pneumatic) actuator, the fluid actuator may be communicatively coupled to the controller via a valve assembly, which is controlled by the controller to control fluid flow to/from the fluid actuator. As discussed in detail below, the controller 104 is configured to control the front row actuator 98 to adjust the front angle 58 of the front row 50 of disc blades 34 relative to the lateral axis 60 of the tillage implement 10 based on the amount of residue at the location of the tillage implement 10. In addition, the controller 104 is configured to control the rear row actuator 100 to adjust the rear angle 62 of the rear row 52 of disc blades 34 relative to the lateral axis 60 of the tillage implement 10 based on the degree of soil compaction at the location of the tillage implement 10.

In certain embodiments, the controller 104 is an electronic controller having electrical circuitry configured to control the front angle of the front row of disc blades and the rear angle of the rear row of disc blades. In the illustrated embodiment, the controller 104 includes a processor, such as the illustrated microprocessor 106, and a memory device 108. The controller 104 may also include one or more storage devices and/or other suitable components. The processor 106 may be used to execute software, such as software for controlling the front angle of the front row of disc blades and the rear angle of the rear row of disc blades, and so forth. Moreover, the processor 106 may include multiple microprocessors, one or more “general-purpose” microprocessors, one or more special-purpose microprocessors, and/or one or more application specific integrated circuits (ASICS), or some combination thereof. For example, the processor 106 may include one or more reduced instruction set (RISC) processors.

The memory device 108 may include a volatile memory, such as random access memory (RAM), and/or a nonvolatile memory, such as read-only memory (ROM). The memory device 108 may store a variety of information and may be used for various purposes. For example, the memory device 108 may store processor-executable instructions (e.g., firmware or software) for the processor 106 to execute, such as instructions for controlling the front angle of the front row of disc blades and the rear angle of the rear row of disc blades, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the front angle of the front row of disc blades and the rear angle of the rear row of disc blades, etc.), and any other suitable data.

In certain embodiments, the controller 104 is configured to control the front row actuator 98 to reduce the front angle 58 in response to a decrease in the amount of residue at the location of the tillage implement 10, and the controller 104 is configured to control the front row actuator 98 to increase the front angle 58 in response to an increase in the amount of residue at the location of the tillage implement 10. For example, while less residue is present on the surface of the field, reducing the front angle 58 may reduce the angle between the disc blades 34 of the front row 50 and the direction of travel 24, thereby enabling the disc blades 34 of the front row 50 to cut and size the residue, while reducing the amount of residue that is buried. As a result, a desired residue coverage (e.g., residue coverage with enhanced agronomic performance) on the surface of the field may be established. Furthermore, while more residue is present on the surface of the field, increasing the front angle 58 may increase the angle between the disc blades 34 of the front row 50 and the direction of travel 24, thereby enabling the disc blades 34 of the front row 50 to increase the amount of residue that is buried. As a result, a desired residue coverage (e.g., residue coverage with enhanced agronomic performance) on the surface of the field may be established. Because the controller 104 adjusts the front angle 58 during movement of the tillage implement 10 through the field, the effectiveness of the tilling process may be enhanced (e.g., as compared to a tillage implement having a fixed front angle).

In certain embodiments, the controller 104 is configured to determine a target front angle based on the amount of residue at the location of the tillage implement and control the front row actuator 98 to adjust the front angle 58 to substantially match the target front angle (e.g., such that the front angle 58 is within a threshold range of the target front angle). For example, in certain embodiments, the disc blade angle adjustment system may include angle sensor(s) configured to output sensor signal(s) indicative of the front angle, and the controller may determine the front angle based on feedback from the angle sensor(s). Accordingly, the controller 104 may control the front row actuator 98 to adjust the front angle 58 to substantially match the target front angle. Furthermore, in certain embodiments, the controller 104 may control the front row actuator 98 (e.g., based on feedback from the angle sensor(s)) to adjust the front angle 58 by an adjustment increment in response to a change (e.g., increase or decrease) in the amount of residue at the location of the tillage implement 10. The adjustment increment may be a fixed increment or a variable increment (e.g., based on the change in the amount of residue at the location of the tillage implement 10).

In certain embodiments, the controller 104 is configured to control the rear row actuator 100 to reduce the rear angle 62 in response to a decrease in the degree of soil compaction at the location of the tillage implement 10, and the controller 104 is configured to control the rear row actuator 100 to increase the rear angle 62 in response to an increase in the degree of soil compaction at the location of the tillage implement 10. For example, while the soil is less compacted, reducing the rear angle 62 may reduce resistance of the disc blades 34 of the rear row 52 through the soil, thereby reducing work vehicle energy consumption (e.g., fuel usage). Furthermore, while the soil is more compacted, increasing the rear angle 62 may enhance the disruption to the compacted soil, thereby reducing soil compaction. As a result, crop emergence may be enhanced, thereby increasing crop yield. Because the controller 104 adjusts the rear angle 62 during movement of the tillage implement 10 through the field, the effectiveness of the tilling process may be enhanced and/or the work vehicle energy consumption may be reduced (e.g., as compared to a tillage implement having a fixed front angle).

In certain embodiments, the controller 104 is configured to determine a target rear angle based on the degree of soil compaction at the location of the tillage implement and control the rear row actuator 100 to adjust the front angle 62 to substantially match the target rear angle (e.g., such that the rear angle 62 is within a threshold range of the target rear angle). For example, in certain embodiments, the disc blade angle adjustment system may include angle sensor(s) configured to output sensor signal(s) indicative of the rear angle, and the controller may determine the rear angle based on feedback from the angle sensor(s). Accordingly, the controller 104 may control the rear row actuator 100 to adjust the rear angle 62 to substantially match the target rear angle. Furthermore, in certain embodiments, the controller 104 may control the rear row actuator 100 (e.g., based on feedback from the angle sensor(s)) to adjust the rear angle 62 by an adjustment increment in response to a change (e.g., increase or decrease) in the degree of soil compaction at the location of the tillage implement 10. The adjustment increment may be a fixed increment or a variable increment (e.g., based on the change in the degree of soil compaction at the location of the tillage implement 10).

In embodiments in which the disc blade angle adjustment system includes angle sensor(s), each angle sensor may include any suitable type(s) of sensing device(s) configured to monitor the angle of the respective row of disc blades. For example, at least one angle sensor may include a potentiometer coupled to the implement frame and to a respective disc blade support. Furthermore, in certain embodiments, at least one angle sensor may be integrated within a respective row actuator. For example, the row actuator (e.g., linear actuator) may include a linear variable differential transformer (LVDT) or a linear potentiometer configured to output a sensor signal indicative of the angle of the respective disc blade support/angle of the respective row of disc blades based on extension and retraction of the row actuator.

In the illustrated embodiment, the disc blade angle adjustment system 12 includes the residue sensor 54, which is communicatively coupled to the controller 104. In addition, in the illustrated embodiment, the disc blade angle adjustment system 12 includes the soil compaction sensor 56, which is communicatively coupled to the controller 104. In the illustrated embodiment, the residue sensor 54 is coupled to the central longitudinal member 80 of the implement frame 14. However, in other embodiments, the residue sensor may be coupled to another suitable component of the implement frame, to another suitable component of the tillage implement (e.g., the hitch frame, etc.), or to the work vehicle. Furthermore, in the illustrated embodiment, the soil compaction sensor 56 is coupled to the central longitudinal member 80 of the implement frame 14. However, in other embodiments, the soil compaction sensor may be coupled to another suitable component of the implement frame, to another suitable component of the tillage implement (e.g., the hitch frame, etc.), or to the work vehicle.

As previously discussed, the residue sensor 54 is configured to output a sensor signal indicative of the amount of residue at the location of the tillage implement 10 within the field. The controller 104 is configured to determine the amount of residue at the location of the tillage implement 10 based on the sensor signal. In addition, the soil compaction sensor 56 is configured to output a sensor signal indicative of the degree of soil compaction at the location of the tillage implement 10 within the field. The controller 104 is configured to determine the degree of soil compaction at the location of the tillage implement 10 based on the sensor signal. Accordingly, the controller 104 may control the front row actuator 98 and the rear row actuator 100 based on feedback from the residue sensor 54 and the soil compaction sensor 56, respectively.

In certain embodiments, the controller 104 is configured to determine the amount of residue at the location of the tillage implement 10 based on a residue map. For example, the residue map may include a two-dimensional plot of the amount of residue on the surface of the field. The residue map may be established before tillage operations are performed, and the residue map may be stored within the controller 104. For example, the residue map may be established based on feedback from residue sensor(s) mounted to a harvester (e.g., which monitor the amount of residue on the surface of the field during harvesting operations), from residue sensor(s) mounted on an uncrewed aerial vehicle (UAV) (e.g., which monitor the amount of residue on the surface of the field prior to tillage operations), from residue sensor(s) mounted on a scout vehicle (e.g., which monitor the amount of residue on the surface of the field prior to tillage operations), etc. In certain embodiments, the disc blade angle adjustment system 12 includes a spatial locating device 110 (e.g., global positioning system (GPS) receiver, inertial measurement unit (IMU), etc.) configured to output a position signal to the controller 104 indicative of the location of the tillage implement 10. The controller 104 may determine the location of the tillage implement 10 based on the position signal, and the controller 104 may determine the amount of residue at the location of the tillage implement 10 based on the residue map and the location of the tillage implement 10. In certain embodiments, the controller 104 may determine the amount of residue at the location of the tillage implement 10 based on feedback from the residue sensor 54 alone, based on the residue map/position signal alone, or based on a combination of feedback from the residue sensor 54 and the residue map/position signal. In embodiments in which the controller determines the amount of residue at the location of the tillage implement based on the residue sensor alone, the spatial locating device may be omitted, and in embodiments in which the controller determines the amount of residue at the location of the tillage implement based on the residue map/position signal alone, the residue sensor may be omitted.

In certain embodiments, the controller 104 is configured to determine the degree of soil compaction at the location of the tillage implement 10 based on a soil compaction map. For example, the soil compaction map may include a two-dimensional plot of the degree of soil compaction within the field. The soil compaction map may be established before tillage operations are performed, and the soil compaction map may be stored within the controller 104. For example, the soil compaction map may be established based on feedback from soil compaction sensor(s) mounted to a harvester (e.g., which monitor the degree of soil compaction within the field during harvesting operations), from soil compaction sensor(s) mounted on a scout vehicle (e.g., which monitor the degree of soil compaction within the field prior to tillage operations), etc. The controller 104 may determine the location of the tillage implement 10 based on the position signal from the spatial locating device 110, and the controller 104 may determine the degree of soil compaction at the location of the tillage implement 10 based on the soil compaction map and the location of the tillage implement 10. In certain embodiments, the controller 104 may determine the degree of soil compaction at the location of the tillage implement 10 based on feedback from the soil compaction sensor 56 alone, based on the soil compaction map/position signal alone, or based on a combination of feedback from the soil compaction sensor 56 and the soil compaction map/position signal. In embodiments in which the controller determines the degree of soil compaction at the location of the tillage implement based on the soil compaction sensor alone, the spatial locating device may be omitted, and in embodiments in which the controller determines the degree of soil compaction at the location of the tillage implement based on the soil compaction map/position signal alone, the soil compaction sensor may be omitted.

While the controller 104 is configured to control the front row actuator 98 based on the amount of residue at the location of the tillage implement 10 alone in the illustrated embodiment, in other embodiments, the controller may be configured to control the front row actuator based on the amount of residue at the location of the tillage implement and one or more other suitable residue parameters at the location of the tillage implement, such as residue size, residue type, residue pattern/distribution, other suitable residue parameters, or a combination thereof. Furthermore, while the controller 104 is configured to control the rear row actuator 100 based on the degree of soil compaction at the location of the tillage implement 10 alone in the illustrated embodiment, in other embodiments, the controller may be configured to control the rear row actuator based on the degree of soil compaction at the location of the tillage implement and one or more other suitable soil parameters at the location of the tillage implement, such as soil density, soil moisture content, soil composition, clod size, other suitable soil parameters, or a combination thereof. Furthermore, in certain embodiments, the tillage implement may include one or more additional rows of disc blades. In such embodiments, the controller may control the angle(s) of the additional row(s) of disc blades based on any suitable parameter(s). In addition, in certain embodiments, the disc blade angle adjustment system may not adjust the front angle of the front row of disc blades based on the amount of residue at the location of the tillage implement, and/or the disc blade angle adjustment system may not adjust the rear angle of the rear row of disc blades based on the degree of soil compaction. In such embodiments, the respective row actuator(s) may be omitted.

Furthermore, in certain embodiments, the controller is configured to control the front angle and/or the rear angle in response to detecting plugging of the respective disc blades. For example, in certain embodiments, the controller is configured to control the front row actuator to adjust the front angle of the front row of disc blades to zero degrees in response to detecting plugging of one or more disc blades of the front row (e.g., the degree of plugging of one or more disc blades exceeds a threshold value). Additionally or alternatively, in certain embodiments, the controller is configured to control the rear row actuator to adjust the rear angle of the rear row of disc blades to zero degrees in response to detecting plugging of one or more disc blades of the rear row (e.g., the degree of plugging of one or more disc blades exceeds a threshold value). In certain embodiments, the disc blade angle adjustment system may include plugging sensor(s) communicatively coupled to the controller and configured to output sensor signal(s) indicative of plugging of the disc blade(s) of the front row and/or the disc blade(s) of the rear row, and the controller may be configured to detect plugging based on the sensor signal(s). In certain embodiments, the plugging sensor(s) may include optical sensor(s) (e.g., camera(s)) directed to one or more disc blades, contact sensor(s) positioned at the disc blade(s), capacitive sensor(s), infrared sensor(s), other suitable type(s) of sensor(s), or a combination thereof. Adjusting the angle of the row of disc blades to zero degrees may facilitate clearing of the plugging as the tillage implement moves through the field. In response to detecting the plugging has been sufficiently reduced (e.g., the degree of plugging is below a threshold value), the controller may control the row actuator(s) to adjust the angle(s) of the row(s) of disc blades to initial angle(s) (e.g., angle(s) before detection of the plugging).

In the illustrated embodiment, controlling the front angle 58 of the front row 50 of disc blades 34 includes controlling the front angle 58 of the right section 64 and the front angle 58 of the left section 66 together (e.g., such that the front angle 58 of the right section 64 is the same as the front angle 58 of the left section 66). However, in other embodiments, the front angle of the right section may be controlled independently of the front angle of the left section. For example, the controller may be configured to determine the amount of residue at the location of the right section (e.g., right half) of the tillage implement (e.g., via a right residue sensor, via the residue map), and the controller may control the front angle of the right section of the front row of disc blades based on the amount of residue at the location of the right section (e.g., via a right front row actuator). Furthermore, the controller may be configured to determine the amount of residue at the location of the left section (e.g., left half) of the tillage implement (e.g., via a left residue sensor, via the residue map), and the controller may control the front angle of the left section of the front row of disc blades based on the amount of residue at the location of the left section (e.g., via a left front row actuator).

In addition, in the illustrated embodiment, controlling the rear angle 62 of the rear row 52 of disc blades 34 includes controlling the rear angle 62 of the right section 68 and the rear angle 62 of the left section 70 together (e.g., such that the rear angle 62 of the right section 68 is the same as the rear angle 62 of the left section 70). However, in other embodiments, the rear angle of the right section may be controlled independently of the rear angle of the left section. For example, the controller may be configured to determine the degree of soil compaction at the location of the right section (e.g., right half) of the tillage implement (e.g., via a right soil compaction sensor, via the soil compaction map), and the controller may control the rear angle of the right section of the rear row of disc blades based on the degree of soil compaction at the location of the right section (e.g., via a right rear row actuator). Furthermore, the controller may be configured to determine the degree of soil compaction at the location of the left section (e.g., left half) of the tillage implement (e.g., via a left soil compaction sensor, via the soil compaction map), and the controller may control the rear angle of the left section of the rear row of disc blades based on the degree of soil compaction at the location of the left section (e.g., via a left rear row actuator).

In embodiments in which the front angles of the right and left sections of the front row are independently controllable, the front slider may be omitted, each respective disc blade support may be pivotally coupled to the implement frame, and a respective front row actuator may drive each respective disc blade support to rotate relative to the implement frame. Furthermore, in embodiments in which the rear angles of the right and left sections of the rear row are independently controllable, the rear slider may be omitted, each respective disc blade support may be pivotally coupled to the implement frame, and a respective rear row actuator may drive each respective disc blade support to rotate relative to the implement frame. In addition, in certain embodiments, the agricultural implement may have any other suitable configuration that enables the rows of disc blades to rotate relative to the implement frame, thereby enabling the disc blade angle adjustment system to adjust the front angle of the front row of disc blades and the rear angle of the rear row of disc blades.

Furthermore, in certain embodiments, at least one row of disc blades may include disc blades in addition to the disc blades of the right section and the left section. For example, in certain embodiments, the front row of disc blades may include one or more additional disc blades rotatably coupled to the front slider, and/or the rear row of disc blades may include one or more additional disc blades rotatably coupled to the rear slider. The additional disc blade(s) are configured to engage the soil in a lateral region between the right and left sections of the respective row. In certain embodiments, the additional disc blade(s) of the front row may be arranged in one or more gangs, and/or at least a portion of the additional disc blade(s) of the front row (e.g., all of the additional disc blade(s) of the front row) may be independently mounted to the front slider. Additionally or alternatively, in certain embodiments, the additional disc blade(s) of the rear row may be arranged in one or more gangs, and/or at least a portion of the additional disc blade(s) of the rear row (e.g., all of the additional disc blade(s) of the rear row) may be independently mounted to the rear slider. At least a portion of the additional disc blade(s) may be mounted to the respective slider(s) at a fixed angle (e.g., zero degrees relative to the longitudinal axis), and/or the angle(s) of at least a portion of the additional disc blades(s) may be adjustable. For example, in certain embodiments, the disc blade angle adjustment system may include front additional disc blade actuator(s) and/or rear additional disc blade actuator(s). The additional disc blade actuator(s) are configured to control the angle of the additional disc blade(s) relative to the longitudinal axis of the tillage implement/direction of travel of the tillage implement. In certain embodiments, the additional disc blade actuator(s) are communicatively coupled to the controller, and the controller is configured to control each additional disc blade actuator to rotate the additional disc blade(s) to the angle of the disc blades of the respective row (e.g., such that all of the disc blades of the respective row are oriented at the same angle relative to the longitudinal axis/direction of travel of the tillage implement).

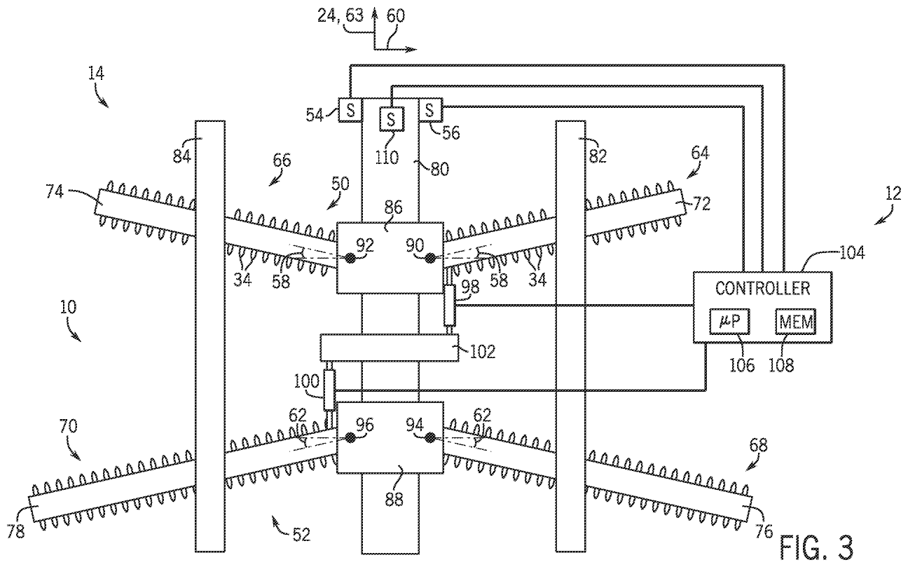

FIG. 3 is a block diagram of the disc blade angle adjustment system 12 of FIG. 2, in which the front row 50 of disc blades 34 is oriented at a front angle 58 (e.g., second front angle) and the rear row 52 of disc blades 34 is oriented at a rear angle 62 (e.g., second rear angle). In the illustrated embodiment, the front slider 86 is moved rearwardly relative to the position of the slider 86 in FIG. 2, thereby increasing the front angle 58 of the front row 50 of disc blades 34 relative to the front angle 58 in FIG. 2. However, the front slider 86 may also be moved forwardly relative to the position of the front slider 86 in FIG. 2, thereby increasing the front angle 58 of the front row 50 of disc blades 34 relative to the front angle 58 in FIG. 2. Furthermore, in the illustrated embodiment, the rear slider 88 is moved forwardly relative to the position of the slider 86 in FIG. 2, thereby increasing the rear angle 62 of the rear row 52 of disc blades 34 relative to the rear angle 62 in FIG. 2. However, the rear slider 88 may also be moved rearwardly relative to the position of the rear slider 88 in FIG. 2, thereby increasing the rear angle 62 of the rear row 52 of disc blades 34 relative to the rear angle 62 in FIG. 2.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A disc blade angle adjustment system for a tillage implement, comprising:
a controller comprising a memory and a processor, wherein the controller is configured to:
control a front row actuator to adjust a front angle of a front row of disc blades relative to a lateral axis of the tillage implement based on an amount of residue at a location of the tillage implement; and
control a rear row actuator to adjust a rear angle of a rear row of disc blades relative to the lateral axis of the tillage implement based on a degree of soil compaction at the location of the tillage implement.

2. The disc blade angle adjustment system of claim 1, wherein the controller is configured to determine the amount of residue at the location of the tillage implement based on feedback from a residue sensor.

3. The disc blade angle adjustment system of claim 1, wherein the controller is configured to determine the degree of soil compaction at the location of the tillage implement based on feedback from a soil compaction sensor.

4. The disc blade angle adjustment system of claim 1, wherein the controller is configured to determine the amount of residue at the location of the tillage implement based on a residue map.

5. The disc blade angle adjustment system of claim 1, wherein the controller is configured to determine the degree of soil compaction at the location of the tillage implement based on a soil compaction map.

6. The disc blade angle adjustment system of claim 1, wherein the controller is configured to:
control the front row actuator to reduce the front angle in response to a decrease in the amount of residue at the location of the tillage implement; and
control the front row actuator to increase the front angle in response to an increase in the amount of residue at the location of the tillage implement.

7. The disc blade angle adjustment system of claim 1, wherein the controller is configured to:
control the rear row actuator to reduce the rear angle in response to a decrease in the degree of soil compaction at the location of the tillage implement; and
control the rear row actuator to increase the rear angle in response to an increase in the degree of soil compaction at the location of the tillage implement.

8. A disc blade angle adjustment system for a tillage implement, comprising:
a front row actuator configured to adjust a front angle of a front row of disc blades relative to a lateral axis of the tillage implement;
a rear row actuator configured to adjust a rear angle of a rear row of disc blades relative to the lateral axis of the tillage implement; and
a controller comprising a memory and a processor, wherein the controller is communicatively coupled to the front row actuator and to the rear row actuator, and the controller is configured to:
control the front row actuator based on an amount of residue at a location of the tillage implement; and
control the rear row actuator based on a degree of soil compaction at the location of the tillage implement.

9. The disc blade angle adjustment system of claim 8, comprising a residue sensor communicatively coupled to the controller, wherein the residue sensor is configured to output a sensor signal indicative of the amount of residue at the location of the tillage implement, and the controller is configured to determine the amount of residue at the location of the tillage implement based on the sensor signal.

10. The disc blade angle adjustment system of claim 8, comprising a soil compaction sensor communicatively coupled to the controller, wherein the soil compaction sensor is configured to output a sensor signal indicative of the degree of soil compaction at the location of the tillage implement, and the controller is configured to determine the degree of soil compaction at the location of the tillage implement based on the sensor signal.

11. The disc blade angle adjustment system of claim 8, wherein the controller is configured to determine the amount of residue at the location of the tillage implement based on a residue map.

12. The disc blade angle adjustment system of claim 8, wherein the controller is configured to determine the degree of soil compaction at the location of the tillage implement based on a soil compaction map.

13. A tillage implement, comprising:
a frame;
a front disc blade support pivotally coupled to the frame, wherein the front disc blade support is configured to support a front row of disc blades;
a rear disc blade support pivotally coupled to the frame, wherein the rear disc blade support is configured to support a rear row of disc blades; and
a disc blade angle adjustment system, comprising:
a front row actuator configured to adjust a front angle of the front row of disc blades relative to a lateral axis of the tillage implement;
a rear row actuator configured to adjust a rear angle of the rear row of disc blades relative to the lateral axis of the tillage implement; and
a controller comprising a memory and a processor, wherein the controller is communicatively coupled to the front row actuator and to the rear row actuator, and the controller is configured to:
control the front row actuator based on an amount of residue at a location of the tillage implement; and
control the rear row actuator based on a degree of soil compaction at the location of the tillage implement.

14. The tillage implement of claim 13, wherein the frame comprises:
a central longitudinal member and an outward longitudinal member;
a front slider slidably coupled to the central longitudinal member; and
a rear slider slidably coupled to the central longitudinal member;
wherein the front disc blade support is pivotally coupled to the front slider, the front disc blade support is pivotally and translatably coupled to the outward longitudinal member, the rear disc blade support is pivotally coupled to the rear slider, and the rear disc blade support is pivotally and translatably coupled to the outward longitudinal member.

15. The tillage implement of claim 14, wherein the front row actuator is coupled to the front disc blade support and to the central longitudinal member, and the rear row actuator is coupled to the rear disc blade support and to the central longitudinal member.

16. The tillage implement of claim 13, comprising:
a second front disc blade support configured to support a second section of the front row of disc blades; and
a second rear disc blade support configured to support a second section of the rear row of disc blades;
wherein the frame comprises a second outward longitudinal member, the second front disc blade support is pivotally coupled to the front slider, the second front disc blade support is pivotally and translatably coupled to the second outward longitudinal member, the second rear disc blade support is pivotally coupled to the rear slider, and the second rear disc blade support is pivotally and translatably coupled to the second outward longitudinal member.

17. The tillage implement of claim 13, wherein the disc blade angle adjustment system comprises a residue sensor communicatively coupled to the controller, the residue sensor is configured to output a sensor signal indicative of the amount of residue at the location of the tillage implement, and the controller is configured to determine the amount of residue at the location of the tillage implement based on the sensor signal.

18. The tillage implement of claim 13, wherein the disc blade angle adjustment system comprises a soil compaction sensor communicatively coupled to the controller, the soil compaction sensor is configured to output a sensor signal indicative of the degree of soil compaction at the location of the tillage implement, and the controller is configured to determine the degree of soil compaction at the location of the tillage implement based on the sensor signal.

19. The tillage implement of claim 13, wherein the controller is configured to determine the amount of residue at the location of the tillage implement based on a residue map.

20. The tillage implement of claim 13, wherein the controller is configured to determine the degree of soil compaction at the location of the tillage implement based on a soil compaction map.
